(19) United States
(12) Patent Application Publication
(10) Pub. No.: US 2025/0086806 A1
(43) Pub. Date: Mar. 13, 2025

(54) IMAGE PROCESSING METHOD AND APPARATUS, ELECTRONIC DEVICE AND STORAGE MEDIUM

(71) Applicant: Beijing Zitiao Network Technology Co., Ltd., Haidian District, Beijing (CN)

(72) Inventor: Yuanlue ZHU, Beijing (CN)

(21) Appl. No.: 18/730,693

(22) PCT Filed: Jan. 17, 2023
(86) PCT No.: PCT/CN2023/072498

§ 371 Date: Jul. 19, 2024

(30) Foreign Application Priority Data
Jan. 20, 2022 (CN) 202210068603.X

(51) Int. Cl. G06T 7/12; G06F 3/14; G06T 3/40; G06T 5/50; G06T 7/13

(52) U.S. Cl. CPC G06T 7/12; G06F 3/14; G06T 3/40; G06T 5/50; G06T 7/13; G06T 2207/20081; G06T 2207/20221

(57) ABSTRACT

The embodiments of the present disclosure disclose an image processing method and apparatus, an electronic device and a storage medium. The method includes: receiving an edge special effect trigger operation which is input for a target display image and is used for enabling an edge display special effect; displaying, in a target display area and in a first preset display mode, a special effect display edge in the target display image; and displaying, in the target display area and in a second preset display mode, areas, other than the special effect display edge, in the target display image.

### CROSS-REFERENCE TO RELATED APPLICATION(S)

The present disclosure claims the priority to Chinese Application No. 202210068603.X, filed in the China Patent Office on Jan. 20, 2022, and the disclosures of which are incorporated herein by reference in their entireties.

### FIELD

Embodiments of the present disclosure relate to the technical field of image processing, for example, to an image processing method and apparatus, an electronic device and a storage medium.

### BACKGROUND

With the diversification of information and the development of photographing devices, photographing images and sharing same via the photographing devices has become a relatively popular information display manner at present. For example, the images are made into a short video, and image information is displayed in the form of the short video.

When images are displayed in related image display technologies, the images are usually statically displayed, such an image display manner is relatively single and lacks interestingness, and moreover, especially when the images contain a plurality of main bodies, the displayed information has no emphasis, resulting in a poor impression, and thus affecting the user experience.

### SUMMARY

Embodiments of the present disclosure provide an image processing method and apparatus, an electronic device and a storage medium, so as to enrich an image display effect.

In a first aspect, an embodiment of the present disclosure provides an image processing method, including:
receiving an edge effect trigger operation, which is input for a target display image and is used for enabling an edge display effect;
displaying, in a target display area, an effect display edge in the target display image in a first preset display manner; and
displaying, in the target display area, areas other than the effect display edge in the target display image in a second preset display manner.

In a second aspect, an embodiment of the present disclosure further provides an image processing apparatus, including:
a trigger operation receiving module, configured to receive an edge effect trigger operation, which is input for a target display image and is used for enabling an edge display effect;
an edge effect display module, configured to display, in a target display area, an effect display edge in the target display image in a first preset display manner; and
a conventional effect display module, configured to display, in the target display area, areas other than the effect display edge in the target display image in a second preset display manner.

In a third aspect, an embodiment of the present disclosure further provides an electronic device, including:
a processor; and
a storage apparatus, configured to store a program, wherein,
when the program is executed by the processor, the processor implements the image processing method provided in any embodiment of the present disclosure.

In a fourth aspect, an embodiment of the present disclosure further provides a computer-readable storage medium, on which a computer program is stored, wherein the computer program implements, when being executed by a processor, the image processing method provided in any embodiment of the present disclosure.

### BRIEF DESCRIPTION OF THE DRAWINGS

A brief introduction on the drawings which are needed in the description of the embodiments is given below. Apparently, the described drawings are merely some, but not all, of the embodiments to be described in the present utility model, based on which other drawings may be obtained by those ordinary skilled in the art without any creative effort.

FIG. 1 is a schematic flowchart of an image processing method provided in Embodiment 1 of the present disclosure;

FIG. 2 is a schematic flowchart of an image processing method provided in Embodiment 2 of the present disclosure;

FIG. 3 is a schematic flowchart of an image processing method provided in Embodiment 3 of the present disclosure;

FIG. 4 is a schematic flowchart of an image processing method provided in Embodiment 4 of the present disclosure;

FIG. 5 is a schematic flowchart of an image processing method provided in Embodiment 5 of the present disclosure;

FIG. 6 is a schematic structural diagram of an image processing apparatus provided in Embodiment 6 of the present disclosure; and

FIG. 7 is a schematic structural diagram of an electronic device provided in Embodiment 1 of the present disclosure.

### DETAILED DESCRIPTION OF EMBODIMENTS

Hereinafter, embodiments of the present disclosure will be described with reference to the drawings. Although some embodiments of the present disclosure have been illustrated in the drawings, it should be understood that the present disclosure may be implemented in various forms, and these embodiments are provided to help understand the present disclosure more thoroughly and completely. It should be understood that the drawings and embodiments of the present disclosure are for exemplary purposes only.

It should be understood that, various steps recorded in method embodiments of the present disclosure may be executed in different sequences and/or in parallel. In addition, the method embodiments may include additional steps and/or omit executing the steps shown.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present disclosure are only intended to distinguish different apparatuses, modules or units. It should be noted that, the modifiers of “one” and “more” mentioned in the present disclosure are illustrative, and those skilled in the art should understand that the modifiers should be interpreted as “one or more” unless the context clearly indicates otherwise.

The names of messages or information interacted between a plurality of apparatuses in the embodiments of the present disclosure are for illustrative purposes only.

### Embodiment 1

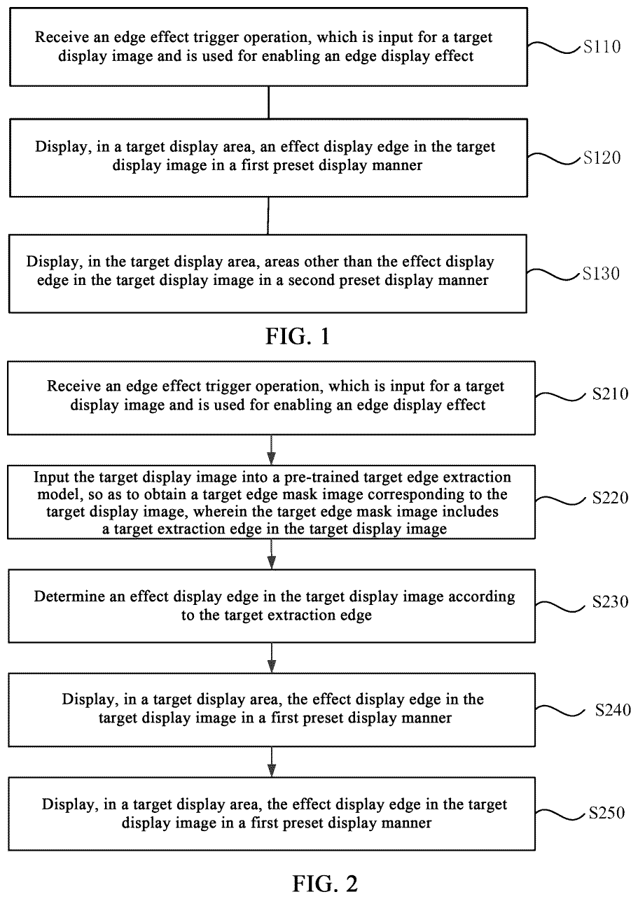

FIG. 1 is a schematic flowchart of an image processing method provided in Embodiment 1 of the present disclosure, the present embodiment is applicable to a case of the image processing method, the method may be executed by an image processing apparatus, and the apparatus may be implemented by software and/or hardware, and may be configured in a terminal and/or a server to implement the image processing method in the embodiment of the present disclosure.

As shown in FIG. 1, the method in the present embodiment may include:

S110, receiving an edge effect trigger operation, which is input for a target display image and is used for enabling an edge display effect.

In the present embodiment, the edge effect trigger operation may be understood as an operation that may trigger a system to enable the edge display effect the operation is executed. There are a plurality of manners for generating the edge effect trigger operation, for example, the edge effect trigger operation may be generated by means of voice information, gesture information, a preset time condition, a preset effect display trigger control, and the like, wherein the preset effect display trigger control may be a virtual identifier disposed on a software interface. The trigger of the preset effect display trigger control may be used for representing to start image display in a preset effect manner. In the embodiment of the present disclosure, an effect display effect may be applied to an effect display edge in the target display image for image display.

Exemplarily, the step: receiving the edge effect trigger operation, which is input for the target display image and is used for enabling the edge display effect, may include at least one of the following operations: receiving voice information containing a target keyword; collecting preset gesture information; receiving a click operation or a press operation, which is input for a preset image display control; and detecting that the target display image contains preset image information, and the like, wherein the preset image information may be preset main body information, such as texts, patterns, buildings or flowers, plants, and trees, etc.

As an optional solution of the embodiment of the present disclosure, the edge effect trigger operation may be generated by uploading an image. Exemplarily, the step: receiving the edge effect trigger operation, which is input for the target display image and is used for enabling the edge display effect, may include: receiving a control trigger operation for a preset edge effect trigger control, and displaying an image acquisition interface, wherein the image acquisition interface includes an image acquisition control; and acquiring the target display image on the basis of the image acquisition control, and receiving an uploading trigger operation for the target display image. In other words, after the preset edge effect trigger control is triggered, the image acquisition interface is displayed, and when an image uploading operation on the image acquisition interface is detected, the uploaded image is used as the target display image, and the edge display effect is enabled for the target display image.

In the present embodiment, the target display image may be understood as an image to be displayed by using the edge display effect. It should be noted that, the acquisition manner and the acquisition occasion of the target display image may be set according to actual requirements. Exemplarily, the target display image may be acquired at first, and then the preset edge effect display control is triggered; or the preset edge effect display control may also be triggered at first, and then the target display image is acquired. The acquisition manner of the target display image may be that the target display image is selected from an existing image library and then is uploaded to the image acquisition interface, and may also be that a photographing apparatus is called on the basis of the image acquisition control to collect the target display image. It is taken as an example that the edge display effect is displayed on a terminal, the acquisition manner may include: clicking the image acquisition control, turning on a camera, photographing the current scene image, and using the photographed current scene image as the target display image.

In the embodiment of the present disclosure, the edge display effect may be understood as a special display effect, which is assigned for the effect display edge in the target display image. It is intended to highlight the effect display edge in the target display image, or display the effect display edge in the target display image in a set manner.

S120. displaying, in a target display area, an effect display edge in the target display image in a first preset display manner.

In the present embodiment, the effect display edge may be understood as an edge that needs to be displayed in a preset edge effect. In the embodiment of the present disclosure, the preset edge display effect may be to display the effect display edge in the first preset display manner. It can be understood that the first preset display manner may be set according to actual requirements. Exemplarily, the first preset display manner may include at least one of the following display manners: displaying in a preset form, wherein the preset form includes at least one of morphological information such as brightness, flicker, color, shape and thickness; superimposing a preset element for display; and performing dynamic display in a preset change manner, wherein the preset change manner may include at least one of various dynamic display manners, such as an edge brightness change, an edge color change, and sequential superposition of effect display in edge pixel points.

It should be noted that, the first preset display manner may also be superimposed display of two or more display manners, for example, display in the preset form and the preset change mode. Exemplarily, the effect display edge in the target display image may also be displayed in the target display area in a flicking mode of changing from dark to bright, or, target edge points at the effect display edge in the target display image are lightened in a preset sequence so as to be dynamically displayed in the target display area. By using the present solution, it is possible to experience an effect of gradually lightening an edge in terms of a visual effect, or having a streaming light effect on the edge. This display manner may highlight the effect display edge in the target display image, thereby improving the image display effect, and improving the user experience.

S130, displaying, in the target display area, areas other than the effect display edge in the target display image in a second preset display manner.

In the present embodiment, the second preset display manner may be understood as a display manner corresponding to the areas other than the effect display edge in the target display image. In the present embodiment, the second preset display manner may be set according to actual requirements. Optionally, the second preset display manner may be a display manner of the image itself, and may also be a display manner, which is preset for the areas other than the effect display edge in the target display image and is different from the display manner of the image itself.

Exemplarily, the second preset display manner may be a display manner different from the first preset display manner. For example, the second preset display manner may be a display manner opposite to the first preset display manner. Optionally, when the first preset display manner is that the edge changes from dark to bright, the second preset display manner may be that the areas other than the effect display edge in the target display image change from bright to dark. When the first preset display manner is that the edge is displayed in a set color, the second preset display manner may be that the areas other than the effect display edge in the target display image are displayed in a preset tone, and the like. The dominant tone of the preset tone may belong to the same color system as the set color, and may also belong to a different color system from the set color.

It should be noted that, “first” and “second” in the “first preset display manner” and the “second preset display manner” are used to distinguish display manners corresponding to different display objects. The preset display manner may be set according to information such as an image style and/or an image type.

In the present embodiment, by means of receiving the edge effect trigger operation, which is input for the target display image and is used for enabling the edge display effect, the effect display requirement of a user for the edge in the target display image may be met by means of interacting with the user; and then, in response to the edge effect trigger operation, the effect display edge in the target display image is displayed in the target display area in the first preset display manner, and the areas other than the effect display edge in the target display image are displayed in the target display area in the second preset display manner, since the effect display edge is displayed different from other image information to highlight the edge information in the target display image, the problems of the image display manner being single and important information being unable to be highlighted in image display are solved, the richness and interestingness of image display are improved, and the visual experience effect of the user is improved.

### Embodiment 2

FIG. 2 is a schematic flowchart of an image processing method provided in Embodiment 2 of the present disclosure. On the basis of any optional implementation in the embodiments of the present disclosure, the present embodiment describes the extraction of the effect display edge in the target display image. Optionally, before the step: displaying, in the target display area, the effect display edge in the target display image in the first preset display manner, the method further includes: inputting the target display image into a pre-trained target edge extraction model, so as to obtain a target edge mask image corresponding to the target display image, wherein the target edge mask image includes a target extraction edge in the target display image; and determining the effect display edge in the target display image according to the target extraction edge. Regarding a specific implementation, reference may be made to the description of the present embodiment. Technical features the same as or similar to those in the foregoing embodiments are not described herein again.

As shown in FIG. 2, the method in the present embodiment may include:

S210, receiving an edge effect trigger operation, which is input for a target display image and is used for enabling an edge display effect.

S220, inputting the target display image into a pre-trained target edge extraction model, so as to obtain a target edge mask image corresponding to the target display image, wherein the target edge mask image includes a target extraction edge in the target display image.

In the present embodiment, the target edge extraction model may be understood as a model for extracting the target extraction edge in the target display image. Optionally, the target edge extraction model may be obtained by training a pre-established initial edge extraction model according to a sample display image and a sample edge mask image corresponding to the sample display image, wherein the sample edge mask image includes an expected extraction edge in the sample display image.

Exemplarily, the initial edge extraction model may include a convolutional neural network and other deep learning networks having image segmentation functions, wherein the convolutional neural network may include at least one of a convolutional neural network (CNN), a recurrent neural network (RNN), a u2net model, a unet model, a deeplab model, a transformer model and a pidinet model.

It can be understood that, before the step of inputting the target display image into the pre-trained target edge extraction model, the method further includes: training the pre-established initial edge extraction model according to the sample display image and the sample edge mask image corresponding to the sample display image. Optionally, the sample display image may be used as the input of the initial edge extraction model, so as to obtain a segmentation edge mask image corresponding to the sample display image, and then model parameters are adjusted according to the segmentation edge mask image corresponding to the sample display image, and the sample edge mask image corresponding to the sample display image, so as to obtain the target extraction edge.

Optionally, the pre-established initial edge extraction model may also be a generative adversarial network. The generative adversarial network may include a generator and a discriminator, wherein the generator may include a semantic segmentation network. Exemplarily, the semantic segmentation network may utilize the foregoing convolutional neural network, and the discriminator may utilize a multi-scale feature discrimination structure.

S230, determining an effect display edge in the target display image according to the target extraction edge.

Optionally, the target extraction edge is used as the effect display edge in the target display image, or, the target extraction edge is selected according to a preset edge selection condition, and the selected target extraction edge is determined to be the effect display edge in the target display image, wherein the preset edge selection condition may be set according to actual situations. For example, the preset edge selection condition may be a continuous length of the target extraction edge, etc.

S240, displaying, in a target display area, the effect display edge in the target display image in a first preset display manner.

S250, displaying, in the target display area, areas other than the effect display edge in the target display image in a second preset display manner.

In the present embodiment, the target edge mask image corresponding to the target display image is obtained by means of the pre-trained target edge extraction model, and then the effect display edge in the target display image is determined according to the target extraction edge, so that the effect display edge in the target display image can be extracted simply, conveniently, quickly and intelligently. In this way, upon receiving the edge effect trigger operation, which is input for the target display image and is used for enabling the edge display effect, a quick response can be made to the edge effect trigger operation.

### Embodiment 3

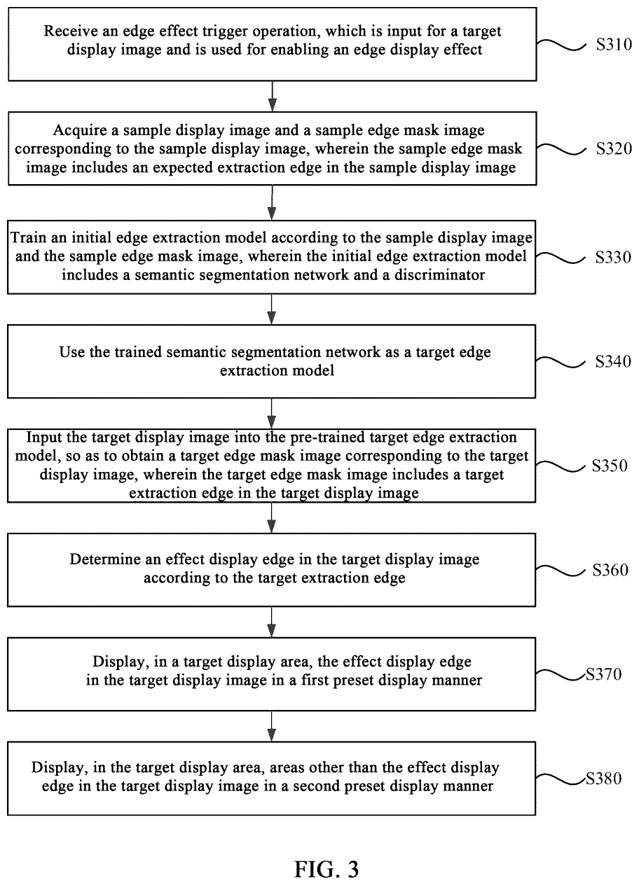

FIG. 3 is a schematic flowchart of an image processing method provided in Embodiment 3 of the present disclosure. On the basis of any optional implementation in the embodiments of the present disclosure, the present embodiment describes the manner of generating the target edge extraction model, so as to more accurately extract the effect edge information of the target display image. Optionally, before the step of inputting the target display image into the pre-trained target edge extraction model, the method further includes: acquiring a sample display image and a sample edge mask image corresponding to the sample display image, wherein the sample edge mask image includes an expected extraction edge in the sample display image; training an initial edge extraction model according to the sample display image and the sample edge mask image, wherein the initial edge extraction model includes a semantic segmentation network and a discriminator; and using the trained semantic segmentation network as the target edge extraction model. Regarding a specific implementation, reference may be made to the description of the present embodiment. Technical features the same as or similar to those in the foregoing embodiments are not described herein again.

As shown in FIG. 3, the method in the present embodiment may include:

S310, receiving an edge effect trigger operation, which is input for a target display image and is used for enabling an edge display effect.

S320, acquiring a sample display image and a sample edge mask image corresponding to the sample display image, wherein the sample edge mask image includes an expected extraction edge in the sample display image.

In the present embodiment, the sample display image may be an original sample image to be subjected to edge extraction. The sample edge mask image may be an image, which corresponds to the sample display image and is used for representing edge information. The expected extraction edge may be understood as edge information, which is expected to be obtained after edge extraction is performed by means of the target edge extraction model.

It should be noted that, the expected extraction edge includes an effect display edge. The effect display edge may be a part of the expected extraction edge, and may also be all the extracted expected extraction edge.

Exemplarily, an initial sample image to be extracted and the sample edge mask image corresponding to the sample display image may be acquired from an existing database. The sample display image may also be acquired at first, and then edge information labeling is performed on the sample display image, so as to obtain the sample edge mask image corresponding to the sample display image.

S330, training an initial edge extraction model according to the sample display image and the sample edge mask image, wherein the initial edge extraction model includes a semantic segmentation network and a discriminator.

In the embodiment of the present disclosure, the initial edge extraction model may be a generative adversarial network. The semantic segmentation network may be understood as a generator in the generative adversarial network, which forms adversary with the discriminator for training. Optionally, the generative adversarial network continuously interacts with the discriminator D by means of the semantic segmentation network G (Generator), so as to continuously optimize its own model parameters to obtain a target edge extraction model.

During a model training process, for the semantic segmentation network, the semantic segmentation network continuously optimizes its own model parameters, so that the discriminator discriminates an image output by the semantic segmentation network to be true, or, the discriminator cannot discriminate which images are images output by the semantic segmentation network; and for the discriminator, the discriminator needs to continuously optimize its own model parameters, so as to accurately discriminate the image output by the semantic segmentation network to be false. Therefore, the model precision is continuously improved.

In the embodiment of the present disclosure, optionally, the step of training the initial edge extraction model according to the sample display image and the sample edge mask image includes: inputting, into the semantic segmentation network, the sample display image as an input image of the semantic segmentation network, so as to obtain a segmentation edge mask image, and then adjusting model parameters of the semantic segmentation network according to a loss between the segmentation edge mask image and the sample edge mask image corresponding to the input image, so as to optimize the semantic segmentation network.

On this basis, optionally, the step of training the initial edge extraction model according to the sample display image and the sample edge mask image further includes: training the discriminator according to an image output by the semantic segmentation network, an expected output image corresponding to the image output by the semantic segmentation network, and an expected discrimination result, so as to optimize the discriminator.

Optionally, in the embodiment of the present disclosure, in addition to serving as an anomaly detector, the discriminator may also adjust the model parameters of the semantic segmentation network according to a model discrimination loss of the discriminator, so that the semantic segmentation network focuses on an unlearned part, thereby improving the edge extraction effect of the semantic segmentation network.

S340, using the trained semantic segmentation network as a target edge extraction model.

In the embodiment of the present disclosure, there are a plurality of manners for determining the completion of model training. Optionally, when a generation loss function of the semantic segmentation network converges, the manner of determining the completion of model training is that the training of the semantic segmentation network is completed; or, when the number of training iterations reaches a preset number threshold value, the manner of determining the completion of model training is that the training of the semantic segmentation network is completed; or, when it is detected that the edge extraction effect of the semantic segmentation network reaches an expected target, the manner of determining the completion of model training is that the training of the semantic segmentation network is completed.

In the present embodiment, the number of training iterations reaching the preset number threshold value may be determined by the number of times for traversing the sample image. The edge extraction effect may be determined according to difference information between an actually output edge mask image of the semantic segmentation network and the sample edge mask image.

S350, inputting the target display image into the pre-trained target edge extraction model, so as to obtain a target edge mask image corresponding to the target display image, wherein the target edge mask image includes a target extraction edge in the target display image.

S360, determining an effect display edge in the target display image according to the target extraction edge.

S370, displaying, in a target display area, the effect display edge in the target display image in a first preset display manner.

S380, displaying, in the target display area, areas other than the effect display edge in the target display image in a second preset display manner.

In the present embodiment, an adversarial network architecture is utilized, the initial edge extraction model is used as the generator in the adversarial network, the semantic segmentation network and the discriminator are alternately trained, and the semantic segmentation network is repeatedly adjusted by means of the training conditions of the discriminator, so that the trained semantic segmentation network has more accurate edge extraction capability, and the effect of edge effect display is ensured.

### Embodiment 4

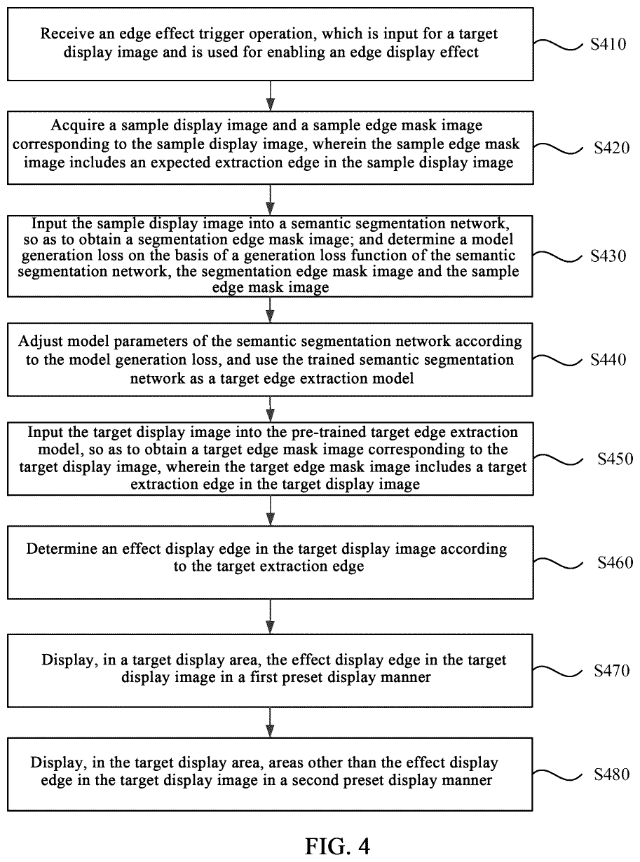

FIG. 4 is a schematic flowchart of an image processing method provided in Embodiment 4 of the present disclosure. On the basis of any optional implementation in the embodiments of the present disclosure, the present embodiment describes the training manner of the semantic segmentation network, so as to improve the precision for extracting the information of the effect edge of the target display image. Optionally, the step of training the initial edge extraction model according to the sample display image and the sample edge mask image includes: inputting the sample display image into the semantic segmentation network, so as to obtain a segmentation edge mask image; determining a model generation loss on the basis of a generation loss function of the semantic segmentation network, the segmentation edge mask image and the sample edge mask image, wherein the model generation loss includes an image generation loss of the semantic segmentation network and an image discrimination loss of the discriminator for the segmentation edge mask image; and adjusting model parameters of the semantic segmentation network according to the model generation loss. Regarding a specific implementation, reference may be made to the description of the present embodiment. Technical features the same as or similar to those in the foregoing embodiments are not described herein again.

As shown in FIG. 4, the method in the present embodiment may include:

S410, receiving an edge effect trigger operation, which is input for a target display image and is used for enabling an edge display effect.

S420, acquiring a sample display image and a sample edge mask image corresponding to the sample display image, wherein the sample edge mask image includes an expected extraction edge in the sample display image.

S430, inputting the sample display image into a semantic segmentation network, so as to obtain a segmentation edge mask image; and determining a model generation loss on the basis of a generation loss function of the semantic segmentation network, the segmentation edge mask image and the sample edge mask image, wherein the model generation loss includes an image generation loss of the semantic segmentation network and an image discrimination loss of a discriminator for the segmentation edge mask image.

In the present embodiment, the generation loss function of the semantic segmentation network may be understood as a function for judging a loss generated when the semantic segmentation network performs edge extraction. In the present embodiment of the present disclosure, the generation loss function of the semantic segmentation network may include only one loss function, and may also include two or more loss functions. Exemplarily, the generation loss function may include a first loss function and a second loss function.

Optionally, the step of determining the model generation loss on the basis of the generation loss function of the semantic segmentation network, the segmentation edge mask image and the sample edge mask image may include: on the basis of the first loss function, calculating a loss between the segmentation edge mask image and the sample edge mask image, so as to serve as the image generation loss of the semantic segmentation network; on the basis of the second loss function, calculating an image discrimination loss between an output discrimination result, which is output by the discriminator and corresponds to the segmentation edge mask image, and an expected discrimination result; and determining the model generation loss of the semantic segmentation network according to the image generation loss and the image discrimination loss.

Exemplarily, the manner of determining the model generation loss of the semantic segmentation network according to the image generation loss and the image discrimination loss may be: performing summation or weighted summation on the image generation loss and the image discrimination loss, so as to obtain the model generation loss of the semantic segmentation network.

In the present embodiment, the first loss function and the second loss function may be the same or different. Exemplarily, the first loss function includes a binary-classification cross entropy loss function, and the second loss function includes a least square loss function.

Optionally, the generation loss function of the semantic segmentation network is expressed on the basis of the following formula:

$${L}_{G} ( G ( x ) , y ) = {L}_{b c e} ( G ( x ) , y ) + {\sum }_{k = 0}^{n} {Σ}_{j = 0}^{m} - {β}_{j} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{G}(G(x),y) represents the generation loss function of the semantic segmentation network; L_{bce}(G(x),y) represents the binary-classification cross entropy loss function for calculating the loss between the segmentation edge mask image and the sample edge mask image; c[G(x),x] represents a false sample image obtained by splicing the segmentation edge mask image with the sample display image; D^{k}(c[G(x),x]) represents an image discrimination result of the false sample image, which is output by a kth layer of network of the discriminator; n represents a maximum value of k and is a positive integer greater than 1; βⱼ represents a weight value of a jth pixel point; and m represents a maximum value of j, and is a positive integer greater than 1.

Since the proportion of edge information in the image in the overall information of the image is often relatively small, in a scenario in which edge extraction is performed by using the model, there may be a problem of sample imbalance when all the pixel points are learned in the same way. Therefore, edge pixel points in the sample edge mask image may be used as positive samples, pixel points other than the edge pixel points in the sample edge mask image are used as negative samples, and the weight corresponding to each pixel point is determined by means of the proportion of the number of pixel points of the positive samples to the total number of pixel points and the proportion of the number of pixel points of the negative samples to the total number of pixel points, so as to achieve a balance. Optionally, before the step: on the basis of the second loss function, calculating the image discrimination loss between the output discrimination result, which is output by the discriminator and corresponds to the segmentation edge mask image, and the expected discrimination result, the method further includes: determining a target weight value of the second loss function according to edge pixel points corresponding to the expected discrimination result, the number of pixel points other than the edge pixel points, and the total number of pixel points corresponding to the expected discrimination result, and performing weighting on the second loss function on the basis of the target weight value. Therefore, it is possible to calculate, by means of weighing, the image discrimination loss between the output discrimination result, which is output by the discriminator and corresponds to the segmentation edge mask image, and the expected discrimination result.

Optionally, before the step of inputting the sample display image into the semantic segmentation network, the method may further include: preprocessing the sample display image, wherein the preprocessing includes at least one of noise reduction processing, sharpening processing, zooming processing, cropping processing, and interpolation processing.

S440, adjusting model parameters of the semantic segmentation network according to the model generation loss, and using the trained semantic segmentation network as a target edge extraction model.

It should be noted that, the purpose of adjusting the model parameters of the semantic segmentation network according to the model generation loss is to make the segmentation edge mask image, which is generated by the semantic segmentation network and corresponds to the sample display image, be closer to the sample edge mask image corresponding to the sample display image, so that the discriminator cannot discriminate the difference between the segmentation edge mask image and the sample edge mask image as much as possible.

S450, inputting the target display image into the pre-trained target edge extraction model, so as to obtain a target edge mask image corresponding to the target display image, wherein the target edge mask image includes a target extraction edge in the target display image.

S460, determining an effect display edge in the target display image according to the target extraction edge.

S470, displaying, in a target display area, the effect display edge in the target display image in a first preset display manner.

S480, displaying, in the target display area, areas other than the effect display edge in the target display image in a second preset display manner.

In the present embodiment, when the model parameters of the semantic segmentation model are adjusted, the segmentation edge mask image output by the semantic segmentation network, the generation loss function and the sample edge mask image are used for determining the image generation loss of the semantic segmentation network and the image discrimination loss of the discriminator for the segmentation edge mask image, thereby not only considering the own image generation loss of the semantic segmentation network in edge extraction, but also combining the image discrimination loss of the discriminator for the segmentation edge mask image, so that the discrimination result of the discriminator for the segmentation edge mask image can be focused on to adjust the segmentation model; and the adversary between the semantic segmentation model and the discriminator is fully applied, so that the trained semantic segmentation network has more accurate edge extraction capability, and the effect of edge effect display is ensured.

### Embodiment 5

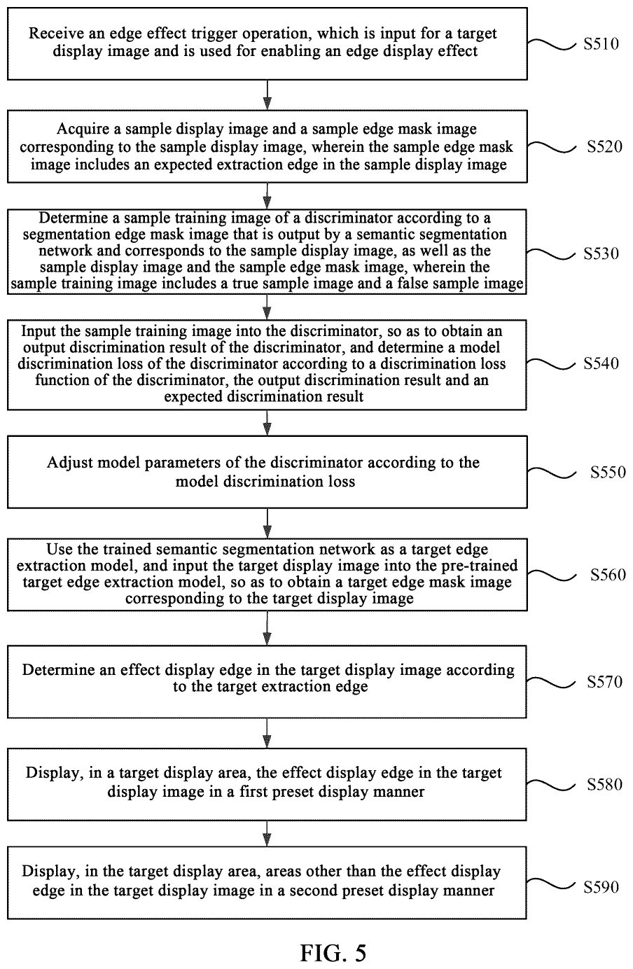

FIG. 5 is a schematic flowchart of an image processing method provided in Embodiment 5 of the present disclosure. On the basis of any optional implementation in the embodiments of the present disclosure, the present embodiment describes the training manner of the discriminator, so as to better assist in improving the training effect of the semantic segmentation network to improve the edge extraction precision. Optionally, the method includes: determining a sample training image of the discriminator according to a segmentation edge mask image that is output by the semantic segmentation network and corresponds to the sample display image, as well as the sample display image and the sample edge mask image, wherein the sample training image includes a true sample image and a false sample image; inputting the sample training image into the discriminator, so as to obtain an output discrimination result of the discriminator, and determining a model discrimination loss of the discriminator according to a discrimination loss function of the discriminator, the output discrimination result and an expected discrimination result; and adjusting model parameters of the discriminator according to the model discrimination loss. Regarding a specific implementation, reference may be made to the description of the present embodiment. Technical features the same as or similar to those in the foregoing embodiments are not described herein again.

As shown in FIG. 5, the method in the present embodiment may include:

S510, receiving an edge effect trigger operation, which is input for a target display image and is used for enabling an edge display effect.

S520, acquiring a sample display image and a sample edge mask image corresponding to the sample display image, wherein the sample edge mask image includes an expected extraction edge in the sample display image.

S530, determining a sample training image of a discriminator according to a segmentation edge mask image that is output by a semantic segmentation network and corresponds to the sample display image, as well as the sample display image and the sample edge mask image, wherein the sample training image includes a true sample image and a false sample image.

Since the mask image is a channel image, in order to adapt to the discriminator, optionally, the sample edge mask image and the segmentation edge mask image may be converted into images of two or more channels in an image splicing manner. Considering that both the sample edge mask image and the segmentation edge mask image correspond to the sample display image, optionally, the sample display image is spliced with the segmentation edge mask image that is output by the semantic segmentation network and corresponds to the sample display image, so as to obtain a false sample image of a discrimination model, and the sample display image is spliced with the sample edge mask image, so as to obtain a true sample image of the discrimination model.

As an optional mode of the embodiment of the present disclosure, the sample edge mask image may also be spliced with the segmentation edge mask image that is output by the semantic segmentation network and corresponds to the sample display image, so as to obtain the false sample image of the discrimination model, and the sample edge mask image is spliced with the sample edge mask image, so as to obtain the true sample image of the discrimination model.

S540, inputting the sample training image into the discriminator, so as to obtain an output discrimination result of the discriminator, and determining a model discrimination loss of the discriminator according to a discrimination loss function of the discriminator, the output discrimination result and an expected discrimination result.

In the present embodiment, the discrimination loss function of the discriminator may be understood as a function for judging a loss generated when the discriminator performs classification discrimination. In the present embodiment of the present disclosure, the discrimination loss function may include only one loss function, and may also include two or more loss functions. Exemplarily, the discrimination loss function includes a third loss function and a fourth loss function. The image discrimination loss of the false sample image in the sample training image may be calculated by means of the third loss function, the image discrimination loss of the true sample image in the sample training image may be calculated by means of the fourth loss function, and then the model discrimination loss of the discriminator is determined on the basis of the image discrimination loss of the false sample image and the image discrimination loss of the true sample image.

Optionally, the step of determining the model discrimination loss of the discriminator according to the discrimination loss function of the discriminator, the output discrimination result and the expected discrimination result may include: according to the third loss function, calculating an output discrimination result and an expected discrimination result, which are output by the discriminator and correspond to the false sample image, so as to determine a false sample discrimination loss of the discriminator; according to the fourth loss function, calculating an output discrimination result and an expected discrimination result, which are output by the discriminator and correspond to the true sample image, so as to determine a true sample discrimination loss of the discriminator; and determining the model discrimination loss of the discriminator according to the false sample discrimination loss and the true sample discrimination loss.

Since the proportion of edge information in the image in the overall information of the image is often relatively small, in a scenario in which edge extraction is performed by using the model, there may be a problem of sample imbalance when all the pixel points are learned in the same way. Therefore, the weight of the third loss function and/or the fourth loss function may be determined by means of the proportion of positive samples to negative sample, so as to achieve a balance.

Exemplarily, the manner of determining the model discrimination loss of the discriminator according to the false sample discrimination loss and the true sample discrimination loss may include: performing summation or weighted summation on the false sample discrimination loss and the true sample discrimination loss, so as to obtain the model discrimination loss of the discriminator.

In the present embodiment, the third loss function and the fourth loss function may be the same or different. Optionally, the third loss function includes a binary-classification cross entropy loss function, and the fourth loss function includes a least square loss function.

Optionally, the model discrimination loss of the discriminator may be expressed on the basis of the following formula:

$${L}_{G} ( G ( x ) , y ) = {L}_{b c e} ( G ( x ) , y ) + {\sum }_{k = 0}^{n} - {α}_{i} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{D}(G(x),y) represents the discrimination loss function of the discriminator; c[G(x),x] represents a false sample image obtained by splicing the segmentation edge mask image with the sample display image; d^{k} represents an expected discrimination result, which is expected to be output by a kth layer of network of the discriminator and corresponds to the false sample image; L_{bce}(D^{k}(c[G(x),x]),d^{k}) represents the binary-classification cross entropy loss function for calculating the loss between the segmentation edge mask image and the sample edge mask image; c[y,x] represents a true sample image obtained by splicing the sample edge mask image with the sample display image; D^{k}(c[y,x]) represents the image discrimination result of the true sample image, which is actually output by the kth layer of network of the discriminator; n represents a maximum value of k and is a positive integer greater than 1; and αᵢ represents a weight value of an ith pixel point.

Optionally, the before the step of determining the model discrimination loss of the discriminator according to the discrimination loss function of the discriminator, the output discrimination result and the expected discrimination result, the method further includes: determining an expected discrimination result, which is expected to be output by the discriminator and corresponds to the sample display image, wherein the expected discrimination result corresponding to the sample display image includes: an expected discrimination result corresponding to the segmentation edge mask image that corresponds to the sample display image, and an expected discrimination result corresponding to the sample edge mask image that corresponds to the sample display image.

If only the conventional training of the semantic segmentation network plus discriminator is involved, the discriminator tends not to play a good role because only the prediction results of local pixel points are wrong in usual prediction results of the segmentation edge mask image, and the prediction results of most pixel points are correct. Most information captured by a conventional discriminator is misleading and thus cannot play a better constraint role. Therefore, optionally, the step: determining the expected discrimination result, which is expected to be output by the discriminator and corresponds to the sample display image, may include: performing expansion processing on the sample edge mask image, so as to obtain a first edge mask image; performing binarization processing on the segmentation edge mask image, so as to obtain a second edge mask image; and performing a multiplication operation on the first edge mask image and the second edge mask image, so as to obtain the expected discrimination result, which is expected to be output by the discriminator and corresponds to the sample display image.

For the segmentation edge mask image, by means of performing the multiplication operation on the first edge mask image obtained by expanding the sample edge mask image, and the second edge mask image obtained by performing binarization processing on the segmentation edge mask image, the interference on edge points by non-edge points of which the pixel values are not 0 in the segmentation edge mask image can be reduced, such that the obtained expected discrimination result mainly focuses on the discrimination of the extracted edge pixel points.

In the embodiment of the present disclosure, the discriminator may be used to perform multi-scale feature discrimination on the sample training image. For example, the multi-scale feature discrimination may be performed by means of an average pooling X4 algorithm, which may also be referred to as a 4-layer average pool manner.

In the embodiment of the present disclosure, the expected discrimination result of each model discrimination layer in the discriminator may be respectively determined. Optionally, after the step: performing the multiplication operation on the first edge mask image and the second edge mask image, so as to obtain the expected discrimination result, which is expected to be output by the discriminator and corresponds to the sample display image, the method further includes:

performing size conversion processing on the expected discrimination result corresponding to the sample display image, and determining a feature value corresponding to each pixel point in each expected discrimination result which has been subjected to size conversion, so as to obtain an expected discrimination result corresponding to each model discrimination layer, wherein the feature value may be understood as a discrimination value for discriminating whether the target area is an edge point.

Exemplarily, the size of the expected discrimination result corresponding to the sample display image is 512×512, and if the expected discrimination result is zoomed to 16×16, the pixel of each small grid actually represents the result of the feature value of 32×32. It can be understood that, 512×512 to 16×16 is equivalent to converting a mean value of every 32× 32 pixels in 512×512 into a pixel value result in 16×16. When the proportion of feature values, which are discriminated to be wrong, in the feature values corresponding to the small grids reaches a preset proportion, for example, the error proportion reaches 1/16, 1/32, 1/64 1/128 and the like, the feature values corresponding to the pixels of the small grids are determined as discrimination errors.

When the model discrimination loss of the discriminator is calculated, a loss value of the expected discrimination result and a loss value of the output discrimination result of each model discrimination layer may be receptively calculated according to the discrimination loss function, and then the model discrimination loss of the discriminator is calculated by means of performing summation, or firstly performing summation and then performing averaging, or firstly performing weighted summation and then performing averaging, etc.

S550, adjusting model parameters of the discriminator according to the model discrimination loss.

It should be noted that, the purpose of adjusting the model parameters of the discriminator according to the model discrimination loss is to improve the discrimination accuracy of the discriminator, so that the discriminator can better discriminate the false sample image and the true sample image. Therefore, adversary is formed with the semantic segmentation network, so that the segmentation edge mask image, which is generated by the semantic segmentation network and corresponds to the sample display image, is closer to the sample edge mask image corresponding to the sample display image.

S560, using the trained semantic segmentation network as a target edge extraction model, and inputting the target display image into the pre-trained target edge extraction model, so as to obtain a target edge mask image corresponding to the target display image, wherein the target edge mask image includes a target extraction edge in the target display image.

S570, determining an effect display edge in the target display image according to the target extraction edge.

S580, displaying, in a target display area, the effect display edge in the target display image in a first preset display manner.

S590, displaying, in the target display area, areas other than the effect display edge in the target display image in a second preset display manner.

In the present embodiment, by means of splicing the sample display image with the segmentation edge mask image, and splicing the sample display image with the sample edge mask image, so as to obtain the sample training image of the discriminator, when the requirements of the discriminator for the input image are met, the sample display image may be associated with the output discrimination result of the discriminator; then the model discrimination loss of the discriminator is determined according to the discrimination loss function of the discriminator, the output discrimination result and the expected discrimination result; and the model parameters of the discriminator are adjusted, so that the discriminator achieves a better discrimination effect, thereby better resisting against the semantic segmentation network, so as to assist in optimizing the semantic segmentation network and improving the effect of edge extraction.

### Embodiment 6

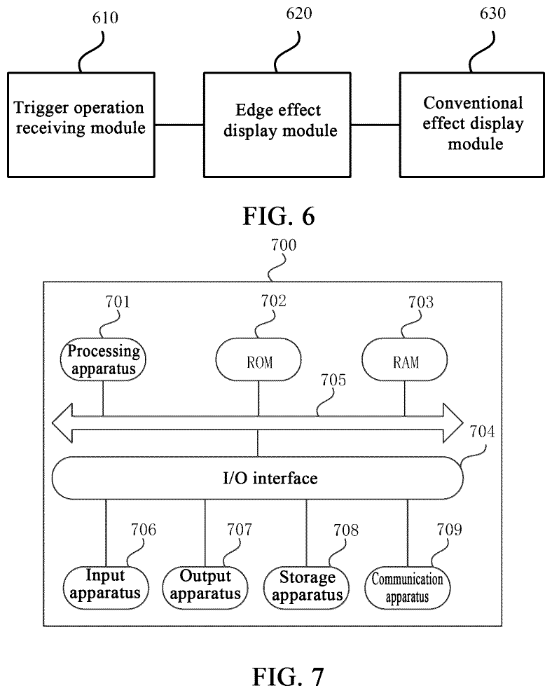

FIG. 6 is a schematic structural diagram of an image processing apparatus provided in Embodiment 6 of the present disclosure, and the image processing apparatus provided in the present embodiment may be implemented by software and/or hardware, and may be configured in a terminal and/or a server to implement the image processing method in the embodiments of the present disclosure. As shown in FIG. 6, the apparatus may include: a trigger operation receiving module 610, an edge effect display module 620, and a conventional effect display module 630.

The trigger operation receiving module 610 is configured to receive an edge effect trigger operation, which is input for a target display image and is used for enabling an edge display effect; the edge effect display module 620 is configured to display, in a target display area, an effect display edge in the target display image in a first preset display manner; and the conventional effect display module 630 is configured to display, in the target display area, areas other than the effect display edge in the target display image in a second preset display manner.

In the present embodiment, by means of receiving the edge effect trigger operation, which is input for the target display image and is used for enabling the edge display effect, the effect display requirement of a user for the edge in the target display image can be met by means of interacting with the user; and then, in response to the edge effect trigger operation, the effect display edge in the target display image is displayed in the target display area in the first preset display manner, and the areas other than the effect display edge in the target display image are displayed in the target display area in the second preset display manner, since the effect display edge is displayed different from other image information to highlight the edge information in the target display image, the problems of the image display manner being single and important information being unable to be highlighted in image display are solved, the richness and interestingness of image display are improved, and the visual experience effect of the user is improved.

On the basis of any optional implementation in the embodiment of the present disclosure, optionally, the edge effect display module is configured to display, in the target display area, the effect display edge in the target display image in the first preset display manner as follows:
lightening target edge points at the effect display edge in the target display image according to a preset sequence, so as to dynamically display the target edge points in the target display area.

On the basis of any optional implementation in the embodiment of the present disclosure, optionally, the trigger operation receiving module is configured to receive, in the following manner, the edge effect trigger operation, which is input for the target display image and is used for enabling the edge display effect:
receiving a control trigger operation for a preset edge effect trigger control, and displaying an image acquisition interface, wherein the image acquisition interface includes an image acquisition control; and
acquiring the target display image on the basis of the image acquisition control, and receiving an uploading trigger operation for the target display image.

On the basis of any optional implementation in the embodiment of the present disclosure, optionally, the image processing apparatus further includes:
a target edge mask image output module, configured to: before displaying, in the target display area, the effect display edge in the target display image in the first preset display manner, input the target display image into a pre-trained target edge extraction model, so as to obtain a target edge mask image corresponding to the target display image, wherein the target edge mask image includes a target extraction edge in the target display image; and
an effect display edge determination module, configured to determine the effect display edge in the target display image according to the target extraction edge.

On the basis of any optional implementation in the embodiment of the present disclosure, optionally, the image processing apparatus further includes:
a sample image acquisition module, configured to: before inputting the target display image into the pre-trained target edge extraction model, acquire a sample display image and a sample edge mask image corresponding to the sample display image, wherein the sample edge mask image includes an expected extraction edge in the sample display image;
a generation model training module, configured to train an initial edge extraction model according to the sample display image and the sample edge mask image, wherein the initial edge extraction model includes a semantic segmentation network and a discriminator; and
a target edge extraction model determination module, configured to use the trained semantic segmentation network as the target edge extraction model.

On the basis of any optional implementation in the embodiment of the present disclosure, optionally, the model training module includes:
a segmentation edge mask image output unit, configured to input the sample display image into the semantic segmentation network, so as to obtain a segmentation edge mask image;
a model generation loss determination unit, configured to determine a model generation loss on the basis of a generation loss function of the semantic segmentation network, the segmentation edge mask image and the sample edge mask image, wherein the model generation loss includes an image generation loss of the semantic segmentation network and an image discrimination loss of the discriminator for the segmentation edge mask image; and
a semantic segmentation network adjustment unit, configured to adjust model parameters of the semantic segmentation network according to the model generation loss.

On the basis of any optional implementation in the embodiment of the present disclosure, optionally, the generation loss function of the semantic segmentation network includes a first loss function and a second loss function; and
correspondingly, the model generation loss determination unit is configured to determine the model generation loss on the basis of the generation loss function of the semantic segmentation network, the segmentation edge mask image and the sample edge mask image in the following manner:
on the basis of the first loss function, calculating a loss between the segmentation edge mask image and the sample edge mask image, so as to serve as the image generation loss of the semantic segmentation network;
on the basis of the second loss function, calculating an image discrimination loss between an output discrimination result, which is output by the discriminator and corresponds to the segmentation edge mask image, and an expected discrimination result; and
determining the model generation loss of the semantic segmentation network according to the image generation loss and the image discrimination loss.

On the basis of any optional implementation in the embodiment of the present disclosure, optionally, the first loss function includes a binary-classification cross entropy loss function, the second loss function includes a least square loss function, and the generation loss function of the semantic segmentation network is expressed on the basis of the following formula:

$${L}_{G} ( G ( x ) , y ) = {L}_{b c e} ( G ( x ) , y ) + {\sum }_{k = 0}^{n} - {α}_{i} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{G}(G(x),y) represents the generation loss function of the semantic segmentation network; L_{bce}(G(x),y) represents the binary-classification cross entropy loss function for calculating the loss between the segmentation edge mask image and the sample edge mask image; c[G(x),x] represents a false sample image obtained by splicing the segmentation edge mask image with the sample display image; D^{k}(c[G(x),x]) represents an image discrimination result of the false sample image, which is output by a kth layer of network of the discriminator; n represents a maximum value of k and is a positive integer greater than 1; and αᵢ represents a weight value of an ith pixel point.

On the basis of any optional implementation in the embodiment of the present disclosure, optionally, the model generation loss determination unit is configured to:
before calculating, on the basis of the second loss function, the image discrimination loss between the output discrimination result, which is output by the discriminator and corresponds to the segmentation edge mask image, and the expected discrimination result, determine a target weight value of the second loss function according to edge pixel points corresponding to the expected discrimination result, the number of pixel points other than the edge pixel points, and the total number of pixel points corresponding to the expected discrimination result, and perform weighting on the second loss function on the basis of the target weight value.

On the basis of any optional implementation in the embodiment of the present disclosure, optionally, the model training module further includes:
a discriminator sample image generation unit, configured to determine a sample training image of the discriminator according to the segmentation edge mask image that is output by the semantic segmentation network and corresponds to the sample display image, as well as the sample display image and the sample edge mask image, wherein the sample training image includes a true sample image and a false sample image;
a model discrimination loss determination unit, configured to input the sample training image into the discriminator, so as to obtain an output discrimination result of the discriminator, and determine a model discrimination loss of the discriminator according to a discrimination loss function of the discriminator, the output discrimination result and the expected discrimination result; and
a discriminator determination unit, configured to adjust model parameters of the discriminator according to the model discrimination loss.

On the basis of any optional implementation in the embodiment of the present disclosure, optionally, the discriminator sample image generation unit is configured to determine the sample training image of the discriminator according to the segmentation edge mask image that is output by the semantic segmentation network and corresponds to the sample display image, as well as the sample display image and the sample edge mask image in the following manner:
splicing the sample display image with the segmentation edge mask image that is output by the semantic segmentation network and corresponds to the sample display image, so as to obtain a false sample image of a discrimination model, and splicing the sample display image with the sample edge mask image, so as to obtain a true sample image of the discrimination model.

On the basis of any optional implementation in the embodiment of the present disclosure, optionally, the discrimination loss function includes a third loss function and a fourth loss function; and
the model discrimination loss determination unit is configured to determine the model discrimination loss of the discriminator according to the discrimination loss function of the discriminator, the output discrimination result and the expected discrimination result in the following manner:
according to the third loss function, calculating an output discrimination result and an expected discrimination result, which are output by the discriminator and correspond to the false sample image, so as to determine a false sample discrimination loss of the discriminator;
according to the fourth loss function, calculating an output discrimination result and an expected discrimination result, which are output by the discriminator and correspond to the true sample image, so as to determine a true sample discrimination loss of the discriminator; and
determining the model discrimination loss of the discriminator according to the false sample discrimination loss and the true sample discrimination loss.

On the basis of any optional implementation in the embodiment of the present disclosure, optionally, the third loss function includes a binary-classification cross entropy loss function, the fourth loss function includes a least square loss function, and the model discrimination loss of the discriminator is expressed on the basis of the following formula:

$${L}_{G} ( G ( x ) , y ) = {L}_{b c e} ( G ( x ) , y ) + {\sum }_{k = 0}^{n} {Σ}_{j = 0}^{m} - {β}_{j} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{D}(G(x),y) represents the discrimination loss function of the discriminator; c[G(x),x] represents a false sample image obtained by splicing the segmentation edge mask image with the sample display image; d^{k} represents an expected discrimination result, which is expected to be output by a kth layer of network of the discriminator and corresponds to the false sample image; L_{bce}(D^{k}(c[G(x),x]),d^{k}) represents the binary-classification cross entropy loss function for calculating the loss between the segmentation edge mask image and the sample edge mask image; c[y,x] represents a true sample image obtained by splicing the sample edge mask image with the sample display image; D^{k}(c[y,x]) represents the image discrimination result of the true sample image, which is actually output by the kth layer of network of the discriminator; n represents a maximum value of k and is a positive integer greater than 1; βⱼ represents a weight value of a jth pixel point; and m represents a maximum value of j, and is a positive integer greater than 1.

On the basis of any optional implementation of the embodiments of the present disclosure, optionally, the model training module further includes:
a sample edge mask image expansion unit, configured to: before determining the model discrimination loss of the discriminator according to the discrimination loss function of the discriminator, the output discrimination result and the expected discrimination result, perform expansion processing on the sample edge mask image, so as to obtain a first edge mask image;
a segmentation edge mask image binarization unit, configured to perform binarization processing on the segmentation edge mask image, so as to obtain a second edge mask image; and
an expected discrimination result generation unit, configured to perform a multiplication operation on the first edge mask image and the second edge mask image, so as to obtain the expected discrimination result, which is expected to be output by the discriminator and corresponds to the sample display image.

The image processing apparatus may execute the image processing method provided in any embodiment of the present disclosure, and has corresponding functional modules and beneficial effects for executing the image processing method.

It is worth noting that, various units and modules included in the image processing apparatus are only divided according to functional logic, as long as corresponding functions may be implemented; and in addition, specific names of various functional units are merely for ease of distinguishing each other.

### Embodiment 7

FIG. 7 is a schematic structural diagram of an electronic device provided in Embodiment 7 of the present disclosure. Referring to FIG. 7 below, it illustrates a schematic structural diagram of an electronic device (e.g., a terminal device or a server in FIG. 7) 700 suitable for implementing the embodiment of the present disclosure. The terminal device in the embodiment of the present disclosure may include mobile terminals such as mobile phones, notebook computers, digital broadcast receivers, personal digital assistants (PDAs), portable Android devices (PADs), portable media players (PMPs), vehicle-mounted terminals (e.g., vehicle-mounted navigation terminals), and the like, and fixed terminals such as digital television (TVs), desktop computers, and the like. The electronic device shown in FIG. 7 is merely an example.

As shown in FIG. 7, the electronic device 700 may include a processing apparatus (e.g., a central processing unit, a graphics processing unit, or the like) 701, the electronic device 700 may execute various suitable actions and processes in accordance with a program stored in a read-only memory (ROM) 702 or a program loaded from a storage apparatus 708 into a random access memory (RAM) 703. In the RAM 703, various programs and data needed by the operations of the electronic device 700 are also stored. The processing apparatus 701, the ROM 702 and the RAM 703 are connected with each other via a bus 705. An input/output (I/O) interface 704 is also connected to the bus 705.

In general, the following apparatuses may be connected to the I/O interface 704: an input apparatus 706, including, for example, a touch screen, a touch pad, a keyboard, a mouse, a camera, a microphone, an accelerometer, a gyroscope, and the like; an output apparatus 707, including, for example, a liquid crystal display (LCD), a speaker, a vibrator, and the like; a storage apparatus 708, including, for example, a magnetic tape, a hard disk, and the like; and a communication apparatus 709. The communication apparatus 709 may allow the electronic device 700 to communicate in a wireless or wired manner with other devices to exchange data. Although FIG. 7 illustrates the electronic device 700 having various apparatuses, it should be understood that not all illustrated apparatuses are required to be implemented or provided. More or fewer apparatuses may alternatively be implemented or provided.

In particular, according to the embodiment of the present disclosure, the processes described above with reference to the flowcharts may be implemented as computer software programs. For example, the embodiment of the present disclosure includes a computer program product, which includes a computer program carried on a non-transitory computer-readable medium, and the computer program contains program codes for executing the method illustrated in the flowcharts. In such an embodiment, the computer program may be downloaded and installed from a network via the communication apparatus 709, or installed from the storage apparatus 708, or installed from the ROM 702. When the computer program is executed by the processing apparatus 701, the above functions defined in the method of the embodiments of the present disclosure are executed.

The names of messages or information interacted between a plurality of apparatuses in the embodiments of the present disclosure are for illustrative purposes only and are not intended to limit the scope of these messages or information.

The electronic device provided in the embodiment of the present disclosure belongs to the same inventive concept as the image processing method provided in the above embodiments, for technical details that are not described in detail in the present embodiment, reference may be made to the above embodiments, and the present embodiment has the same beneficial effects as the above embodiments.

### Embodiment 8

The embodiment of the present disclosure provides a computer storage medium, on which a computer program is stored, wherein the program implements, when being executed by a processor, the image processing method provided in the above embodiments.

It should be noted that, the computer-readable medium described above in the present disclosure may be either a computer-readable signal medium or a computer-readable storage medium, or any combination of the two. The computer-readable storage medium may be, for example, an electrical, magnetic, optical, electromagnetic, infrared, or semiconductor system, apparatus or device, or a combination of any of the above. The computer-readable storage medium may include an electrical connection having one or more wires, a portable computer magnetic disk, a hard disk, a random access memory, a read-only memory, an erasable programmable read-only memory (EPROM or a flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including: an electrical wire, an optical cable, radio frequency (RF), and the like, or any suitable combination thereof.

In some embodiments, a client and a server may perform communication by using any currently known or future-developed network protocol, such as an hypertext transfer protocol (HTTP), and may be interconnected with any form or medium of digital data communication (e.g., a communication network). Examples of the communication network include a local area network (LAN), a wide area network (WAN), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when being executed by the electronic device, cause the electronic device to perform the following operations:
receiving an edge effect trigger operation, which is input for a target display image and is used for enabling an edge display effect;
displaying, in a target display area, an effect display edge in the target display image in a first preset display manner; and
displaying, in the target display area, areas other than the effect display edge in the target display image in a second preset display manner.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer by means of any type of network, including the LAN or the WAN, or it may be connected to an external computer (e.g., by means of the Internet using an Internet service provider).

The flowcharts and block diagrams in the drawings illustrate the system architecture, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that, each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case, for example, a first acquisition unit may also be described as “a unit for acquiring at least two Internet Protocol addresses”.

The functions described herein above may be executed, at least in part, by one or more hardware logic components. For example, example types of the hardware logic components that may be used include: a field programmable gate array (FPGA), an application specific integrated circuit (ASIC), application specific standard parts (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include an electronic, magnetic, optical, electromagnetic, infrared, or semiconductor system, apparatus or device, or any suitable combination thereof. The machine-readable storage medium may include an electrical connection based on one or more wires, a portable computer disk, a hard disk, an RAM, an ROM, an erasable programmable read-only memory (EPROM or a flash memory), an optical fiber, a CD-ROM, an optical storage device, a magnetic storage device, or any suitable combination thereof.

According to one or more embodiments of the present disclosure, Example 1 provides an element display method, wherein the method includes:
receiving an edge effect trigger operation, which is input for a target display image and is used for enabling an edge display effect;
displaying, in a target display area, an effect display edge in the target display image in a first preset display manner; and
displaying, in the target display area, areas other than the effect display edge in the target display image in a second preset display manner.

According to one or more embodiments of the present disclosure, Example 2 provides an element display method, wherein the method further includes:
optionally, the step: displaying, in the target display area, the effect display edge in the target display image in the first preset display manner, includes:
lightening target edge points at the effect display edge in the target display image according to a preset sequence, so as to dynamically display the target edge points in the target display area.

According to one or more embodiments of the present disclosure, Example 3 provides an element display method, wherein the method further includes:
optionally, the step: receiving the edge effect trigger operation, which is input for the target display image and is used for enabling the edge display effect, includes:
receiving a control trigger operation for a preset edge effect trigger control, and displaying an image acquisition interface, wherein the image acquisition interface includes an image acquisition control; and
acquiring the target display image on the basis of the image acquisition control, and receiving an uploading trigger operation for the target display image.

According to one or more embodiments of the present disclosure, Example 4 provides an element display method, wherein the method further includes:
optionally, before the step: displaying, in the target display area, the effect display edge in the target display image in the first preset display manner, the method further includes:
inputting the target display image into a pre-trained target edge extraction model, so as to obtain a target edge mask image corresponding to the target display image, wherein the target edge mask image includes a target extraction edge in the target display image; and
determining the effect display edge in the target display image according to the target extraction edge.

According to one or more embodiments of the present disclosure, Example 5 provides an element display method, wherein the method further includes:
optionally, before the step of inputting the target display image into the pre-trained target edge extraction model, the method further includes:
acquiring a sample display image and a sample edge mask image corresponding to the sample display image, wherein the sample edge mask image includes an expected extraction edge in the sample display image;
training an initial edge extraction model according to the sample display image and the sample edge mask image, wherein the initial edge extraction model includes a semantic segmentation network and a discriminator; and
using the trained semantic segmentation network as the target edge extraction model.

According to one or more embodiments of the present disclosure, Example 6 provides an element display method, wherein the method further includes:
optionally, the step of training the initial edge extraction model according to the sample display image and the sample edge mask image includes:
inputting the sample display image into the semantic segmentation network, so as to obtain a segmentation edge mask image;
determining a model generation loss on the basis of a generation loss function of the semantic segmentation network, the segmentation edge mask image and the sample edge mask image, wherein the model generation loss includes an image generation loss of the semantic segmentation network and an image discrimination loss of the discriminator for the segmentation edge mask image; and
adjusting model parameters of the semantic segmentation network according to the model generation loss.

According to one or more embodiments of the present disclosure, Example 7 provides an element display method, wherein the method further includes:
optionally, the generation loss function of the semantic segmentation network includes a first loss function and a second loss function; and
the step of determining the model generation loss on the basis of the generation loss function of the semantic segmentation network, the segmentation edge mask image and the sample edge mask image includes:
on the basis of the first loss function, calculating a loss between the segmentation edge mask image and the sample edge mask image, so as to serve as the image generation loss of the semantic segmentation network;
on the basis of the second loss function, calculating an image discrimination loss between an output discrimination result, which is output by the discriminator and corresponds to the segmentation edge mask image, and an expected discrimination result; and
determining the model generation loss of the semantic segmentation network according to the image generation loss and the image discrimination loss.

According to one or more embodiments of the present disclosure, Example 8 provides an element display method, wherein the method further includes:
optionally, the first loss function includes a binary-classification cross entropy loss function, the second loss function includes a least square loss function, and the generation loss function of the semantic segmentation network is expressed on the basis of the following formula:

$${L}_{G} ( G ( x ) , y ) = {L}_{b c e} ( G ( x ) , y ) + {\sum }_{k = 0}^{n} - {α}_{i} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{G}(G(x),y) represents the generation loss function of the semantic segmentation network; L_{bce}(G(x),y) represents the binary-classification cross entropy loss function for calculating the loss between the segmentation edge mask image and the sample edge mask image; c[G(x),x] represents a false sample image obtained by splicing the segmentation edge mask image with the sample display image; D^{k}(c[G(x),x]) represents an image discrimination result of the false sample image, which is output by a kth layer of network of the discriminator; n represents a maximum value of k and is a positive integer greater than 1; and αᵢ represents a weight value of an ith pixel point.

According to one or more embodiments of the present disclosure, Example 9 provides an element display method, wherein the method further includes:
optionally, before the step: on the basis of the second loss function, calculating the image discrimination loss between the output discrimination result, which is output by the discriminator and corresponds to the segmentation edge mask image, and the expected discrimination result, the method further includes:
determining a target weight value of the second loss function according to edge pixel points corresponding to the expected discrimination result, the number of pixel points other than the edge pixel points, and the total number of pixel points corresponding to the expected discrimination result, and performing weighting on the second loss function on the basis of the target weight value.

According to one or more embodiments of the present disclosure, Example 10 provides an element display method, wherein the method further includes:
optionally, the step of training the initial edge extraction model according to the sample display image and the sample edge mask image includes:
determining a sample training image of the discriminator according to the segmentation edge mask image that is output by the semantic segmentation network and corresponds to the sample display image, as well as the sample display image and the sample edge mask image, wherein the sample training image includes a true sample image and a false sample image;
inputting the sample training image into the discriminator, so as to obtain an output discrimination result of the discriminator, and determining a model discrimination loss of the discriminator according to a discrimination loss function of the discriminator, the output discrimination result and an expected discrimination result; and
adjusting model parameters of the discriminator according to the model discrimination loss.

According to one or more embodiments of the present disclosure, Example 11 provides an element display method, wherein the method further includes:
optionally, the step: determining the sample training image of the discriminator according to the segmentation edge mask image that is output by the semantic segmentation network and corresponds to the sample display image, as well as the sample display image and the sample edge mask image, includes:
splicing the sample display image with the segmentation edge mask image that is output by the semantic segmentation network and corresponds to the sample display image, so as to obtain a false sample image of a discrimination model, and splicing the sample display image with the sample edge mask image, so as to obtain a true sample image of the discrimination model.

According to one or more embodiments of the present disclosure, Example 12 provides an element display method, wherein the method further includes:
optionally, the discrimination loss function includes a third loss function and a fourth loss function; and
the step of determining the model discrimination loss of the discriminator according to the discrimination loss function of the discriminator, the output discrimination result and the expected discrimination result, includes:
according to the third loss function, calculating an output discrimination result and an expected discrimination result, which are output by the discriminator and correspond to the false sample image, so as to determine a false sample discrimination loss of the discriminator;
according to the fourth loss function, calculating an output discrimination result and an expected discrimination result, which are output by the discriminator and correspond to the true sample image, so as to determine a true sample discrimination loss of the discriminator; and
determining the model discrimination loss of the discriminator according to the false sample discrimination loss and the true sample discrimination loss.

According to one or more embodiments of the present disclosure, Example 13 provides an element display method, wherein the method further includes:
optionally, the third loss function includes a binary-classification cross entropy loss function, the fourth loss function includes a least square loss function, and the model discrimination loss of the discriminator is expressed on the basis of the following formula:

$${L}_{G} ( G ( x ) , y ) = {L}_{b c e} ( G ( x ) , y ) + {\sum }_{k = 0}^{n} {Σ}_{j = 0}^{m} - {β}_{j} ( 1 {( {D}^{k} ( c [ G ( x ) , x ] ) )}^{2}$$

wherein x represents the sample display image; G(x) represents the segmentation edge mask image, which is output by the semantic segmentation network and corresponds to the sample display image; y represents the sample edge mask image corresponding to the sample display image; L_{D}(G(x),y) represents the discrimination loss function of the discriminator; c[G(x),x] represents a false sample image obtained by splicing the segmentation edge mask image with the sample display image; d^{k} represents an expected discrimination result, which is expected to be output by a kth layer of network of the discriminator and corresponds to the false sample image; L_{bce}(D^{k}(c[G(x),x]),d^{k}) represents the binary-classification cross entropy loss function for calculating the loss between the segmentation edge mask image and the sample edge mask image; c[y,x] represents a true sample image obtained by splicing the sample edge mask image with the sample display image; D^{k}(c[y,x]) represents the image discrimination result of the true sample image, which is actually output by the kth layer of network of the discriminator; n represents a maximum value of k and is a positive integer greater than 1; βⱼ represents a weight value of a jth pixel point; and m represents a maximum value of j, and is a positive integer greater than 1.

According to one or more embodiments of the present disclosure, Example 14 provides an element display method, wherein the method further includes:
optionally, before the step of determining the model discrimination loss of the discriminator according to the discrimination loss function of the discriminator, the output discrimination result and the expected discrimination result, the method further includes:
performing expansion processing on the sample edge mask image, so as to obtain a first edge mask image;
performing binarization processing on the segmentation edge mask image, so as to obtain a second edge mask image; and
performing a multiplication operation on the first edge mask image and the second edge mask image, so as to obtain the expected discrimination result, which is expected to be output by the discriminator and corresponds to the sample display image.

According to one or more embodiments of the present disclosure, Example 15 provides an element display apparatus, wherein the apparatus includes:
a trigger operation receiving module, configured to receive an edge effect trigger operation, which is input for a target display image and is used for enabling an edge display effect;
an edge effect display module, configured to display, in a target display area, an effect display edge in the target display image in a first preset display manner; and
a conventional effect display module, configured to display, in the target display area, areas other than the effect display edge in the target display image in a second preset display manner.

What is claimed is:

1. An image processing method, comprising:
receiving an edge effect trigger operation, which is input for a target display image and is used for enabling an edge display effect;
displaying, in a target display area, an effect display edge in the target display image in a first preset display manner; and
displaying, in the target display area, areas other than the effect display edge in the target display image in a second preset display manner.

2. The method according to claim 1, wherein displaying, in the target display area, the effect display edge in the target display image in the first preset display manner, comprises:
lightening target edge points at the effect display edge in the target display image according to a preset sequence, so as to dynamically display the target edge points in the target display area.

3. The method according to claim 1, wherein receiving the edge effect trigger operation, which is input for the target display image and is used for enabling the edge display effect, comprises:
receiving a control trigger operation for a preset edge effect trigger control, and displaying an image acquisition interface, wherein the image acquisition interface comprises an image acquisition control; and
acquiring the target display image on the basis of the image acquisition control, and receiving an uploading trigger operation for the target display image.

4. The method according to claim 1, wherein the method further comprises, before displaying, in the target display area, the effect display edge in the target display image in the first preset display manner:
inputting the target display image into a pre-trained target edge extraction model to obtain a target edge mask image corresponding to the target display image, wherein the target edge mask image comprises a target extraction edge in the target display image; and
determining the effect display edge in the target display image according to the target extraction edge.

5. The method according to claim 4, wherein the method further comprises, before inputting the target display image into the pre-trained target edge extraction model:
acquiring a sample display image and a sample edge mask image corresponding to the sample display image, wherein the sample edge mask image comprises an expected extraction edge in the sample display image;
training an initial edge extraction model according to the sample display image and the sample edge mask image, wherein the initial edge extraction model comprises a semantic segmentation network and a discriminator; and
using the trained semantic segmentation network as the target edge extraction model.

6. The method according to claim 5, wherein training the initial edge extraction model according to the sample display image and the sample edge mask image comprises:
inputting the sample display image into the semantic segmentation network to obtain a segmentation edge mask image;
determining a model generation loss on the basis of a generation loss function of the semantic segmentation network, the segmentation edge mask image and the sample edge mask image, wherein the model generation loss comprises an image generation loss of the semantic segmentation network and an image discrimination loss of the discriminator for the segmentation edge mask image; and
adjusting model parameters of the semantic segmentation network according to the model generation loss.

7. The method according to claim 6, wherein the generation loss function of the semantic segmentation network comprises a first loss function and a second loss function; and
determining the model generation loss on the basis of the generation loss function of the semantic segmentation network, the segmentation edge mask image and the sample edge mask image comprises:
on the basis of the first loss function, calculating a loss between the segmentation edge mask image and the sample edge mask image as the image generation loss of the semantic segmentation network;
on the basis of the second loss function, calculating an image discrimination loss between an output discrimination result, which is output by the discriminator and corresponds to the segmentation edge mask image, and an expected discrimination result; and
determining the model generation loss of the semantic segmentation network according to the image generation loss and the image discrimination loss.

8. The method according to claim 7, wherein the first loss function comprises a binary-classification cross entropy loss function, the second loss function comprises a least square loss function, and the generation loss function of the semantic segmentation network is expressed on the basis of the following formula:
$${L}_{G} ( G ( x ) , y ) = {L}_{b c e} ( G ( x ) , y ) + {\sum }_{k = 0}^{n} - {α}_{i} ( 1 {( {D}^{k} ( c [ G ( x ) , x ] ) )}^{2}$$
wherein x represents the sample display image; G(x) represents the segmentation edge mask image, which is output by the semantic segmentation network and corresponds to the sample display image; y represents the sample edge mask image corresponding to the sample display image; L_{G}(G(x),y) represents the generation loss function of the semantic segmentation network; L_{bce}(G(x),y) represents the binary-classification cross entropy loss function for calculating the loss between the segmentation edge mask image and the sample edge mask image; c[G(x),x] represents a false sample image obtained by splicing the segmentation edge mask image with the sample display image; D^{k}(c[G(x),x]) represents an image discrimination result of the false sample image, which is output by a kth layer of network of the discriminator; n represents a maximum value of k and is a positive integer greater than 1; and αᵢ represents a weight value of an ith pixel point.

9. The method according to claim 7, wherein the method further comprises, before the step: on the basis of the second loss function, calculating the image discrimination loss between the output discrimination result, which is output by the discriminator and corresponds to the segmentation edge mask image, and the expected discrimination result:
determining a target weight value of the second loss function according to edge pixel points corresponding to the expected discrimination result, the number of pixel points other than the edge pixel points, and the total number of pixel points corresponding to the expected discrimination result, and performing weighting on the second loss function on the basis of the target weight value.

10. The method according to claim 5, wherein training the initial edge extraction model according to the sample display image and the sample edge mask image comprises:
determining a sample training image of the discriminator according to a segmentation edge mask image that is output by a semantic segmentation network and corresponds to the sample display image, as well as the sample display image and the sample edge mask image, wherein the sample training image comprises a true sample image and a false sample image;
inputting the sample training image into the discriminator to obtain an output discrimination result of the discriminator, and determining a model discrimination loss of the discriminator according to a discrimination loss function of the discriminator, the output discrimination result and an expected discrimination result; and
adjusting model parameters of the discriminator according to the model discrimination loss.

11. The method according to claim 10, wherein determining the sample training image of the discriminator according to the segmentation edge mask image that is output by the semantic segmentation network and corresponds to the sample display image, as well as the sample display image and the sample edge mask image, comprises:
splicing the sample display image with the segmentation edge mask image that is output by the semantic segmentation network and corresponds to the sample display image to obtain a false sample image of a discrimination model, and splicing the sample display image with the sample edge mask image to obtain a true sample image of a discrimination model.

12. The method according to claim 10, wherein the discrimination loss function comprises a third loss function and a fourth loss function; and
determining the model discrimination loss of the discriminator according to the discrimination loss function of the discriminator, the output discrimination result and the expected discrimination result, comprises:
according to the third loss function, calculating an output discrimination result and an expected discrimination result, which are output by the discriminator and correspond to the false sample image, so as to determine a false sample discrimination loss of the discriminator;
according to the fourth loss function, calculating an output discrimination result and an expected discrimination result, which are output by the discriminator and correspond to the true sample image, so as to determine a true sample discrimination loss of the discriminator; and
determining the model discrimination loss of the discriminator according to the false sample discrimination loss and the true sample discrimination loss.

13. The method according to claim 12, wherein the third loss function comprises a binary-classification cross entropy loss function, the fourth loss function comprises a least square loss function, and the model discrimination loss of the discriminator is expressed on the basis of the following formula:
$${L}_{G} ( G ( x ) , y ) = {L}_{b c e} ( G ( x ) , y ) + {\sum }_{k = 0}^{n} {Σ}_{j = 0}^{m} - {β}_{j} ( 1 {( {D}^{k} ( c [ G ( x ) , x ] ) )}^{2}$$
wherein x represents the sample display image; G(x) represents the segmentation edge mask image, which is output by the semantic segmentation network and corresponds to the sample display image; y represents the sample edge mask image corresponding to the sample display image; L_{D}(G(x),y) represents the discrimination loss function of the discriminator; c[G(x),x] represents a false sample image obtained by splicing the segmentation edge mask image with the sample display image; d^{k} represents an expected discrimination result, which is expected to be output by a kth layer of network of the discriminator and corresponds to the false sample image; L_{bce}(D^{k}(c[G(x),x]),d^{k}) represents the binary-classification cross entropy loss function for calculating the loss between the segmentation edge mask image and the sample edge mask image; c[y,x] represents a true sample image obtained by splicing the sample edge mask image with the sample display image; D^{k}(c[y,x]) represents the image discrimination result of the true sample image, which is actually output by the kth layer of network of the discriminator; n represents a maximum value of k and is a positive integer greater than 1; βⱼ represents a weight value of a jth pixel point; and m represents a maximum value of j, and is a positive integer greater than 1.

14. The method according to claim 7, wherein the method further comprises, determining the model discrimination loss of the discriminator according to the discrimination loss function of the discriminator, the output discrimination result and the expected discrimination result:
performing expansion processing on the sample edge mask image to obtain a first edge mask image;
performing binarization processing on the segmentation edge mask image to obtain a second edge mask image; and
performing a multiplication operation on the first edge mask image and the second edge mask image to obtain the expected discrimination result, which is expected to be output by the discriminator and corresponds to the sample display image.

15. (canceled)

16. An electronic device, comprising:
a processor; and
a storage apparatus, configured to store a program, which, when executed by the processor, causes the processor to
receive an edge effect trigger operation, which is input for a target display image and is used for enabling an edge display effect;
display, in a target display area, an effect display edge in the target display image in a first preset display manner; and
display, in the target display area, areas other than the effect display edge in the target display image in a second preset display manner.

17. A non-transitory computer-readable storage medium having a computer program stored thereon, wherein the computer program, when being executed by a processor, causes the processor to:
receive an edge effect trigger operation, which is input for a target display image and is used for enabling an edge display effect;
display, in a target display area, an effect display edge in the target display image in a first preset display manner; and
display, in the target display area, areas other than the effect display edge in the target display image in a second preset display manner.

18. The electronic device according to claim 16, wherein displaying, in the target display area, the effect display edge in the target display image in the first preset display manner, comprises:
lightening target edge points at the effect display edge in the target display image according to a preset sequence, so as to dynamically display the target edge points in the target display area.

19. The electronic device according to claim 16, wherein receiving the edge effect trigger operation, which is input for the target display image and is used for enabling the edge display effect, comprises:
receiving a control trigger operation for a preset edge effect trigger control, and displaying an image acquisition interface, wherein the image acquisition interface comprises an image acquisition control; and
acquiring the target display image on the basis of the image acquisition control, and receiving an uploading trigger operation for the target display image.

20. The electronic device according to claim 16, wherein, before displaying, in the target display area, the effect display edge in the target display image in the first preset display manner, the processor is further caused to:
inputting the target display image into a pre-trained target edge extraction model to obtain a target edge mask image corresponding to the target display image, wherein the target edge mask image comprises a target extraction edge in the target display image; and
determining the effect display edge in the target display image according to the target extraction edge.

21. The electronic device according to claim 20, wherein, before inputting the target display image into the pre-trained target edge extraction model, the processor is further caused to:
acquiring a sample display image and a sample edge mask image corresponding to the sample display image, wherein the sample edge mask image comprises an expected extraction edge in the sample display image;
training an initial edge extraction model according to the sample display image and the sample edge mask image, wherein the initial edge extraction model comprises a semantic segmentation network and a discriminator; and
using the trained semantic segmentation network as the target edge extraction model.
